(19) United States
(12) Patent Application Publication
(10) Pub. No.: US 2010/0299448 A1
(43) Pub. Date: Nov. 25, 2010

(54) DEVICE FOR THE STREAMING RECEPTION OF AUDIO AND/OR VIDEO DATA PACKETS

(75) Inventor: Jean-Noel Cuoq, Suresnes (FR)

Correspondence Address: PILLSBURY WINTHROP SHAW PITTMAN, LLP, P.O. BOX 10500, MCLEAN, VA, 22102, US

(73) Assignee: SAGEM COMMUNICATIONS SAS, Rueil-Malmaison (FR)

(21) Appl. No.: 12/682,362

(22) PCT Filed: Oct. 6, 2008
(86) PCT No.: PCT/FR2008/051801

§ 371 Date: Aug. 12, 2010

(30) Foreign Application Priority Data
Oct. 10, 2007 (FR) 0758195

(51) Int. Cl. G06F 15/16

(52) U.S. Cl. 709/234

(57) ABSTRACT

A device for the streaming reception of audio and/or video data packets transmitted over a network from a source server, the device including a network buffer memory in which the packets may be stored, the network buffer memory exhibiting a variable buffering time; and a program memory encoded with instructions configured to adapt the buffering time of the packets for the purpose of improved playback performance of the packets and to locally determine the value of at least one quality of service indicator, the instructions configured to adapt the buffering time adapting the time as a function of the value of the indicator.

### TECHNICAL FIELD OF THE INVENTION

The present invention relates to a device for the streaming reception of audio and/or video data packets transmitted over a network from a source server. The invention applies solely to the field of data transmitted in streaming mode, thus data which has to be played in real time: the invention does not relate to data which are downloaded and recorded initially on a receiving device and then subsequently played. The invention relates, more particularly, to the field of devices connected to a data packet transmission network with non-guaranteed quality of services, of the IP type (“Internet Protocol”), the existing IP network architecture, known as “best effort” architecture, which provides no guarantee of the quality of service. Applied to packet-switching networks, the term QoS (acronym for “Quality of Service”) denotes the ability to provide a service in accordance with requirements, in particular, in terms of response time, bandwidth or packet loss. In other words, the invention does not apply to ATM-type networks (“Asynchronous Transfer Mode”), which provide a QoS adapted to different types of traffic. Generally, streaming is a principle used for the “live” transmission of content. Frequently used on the Internet, it permits the playback of an audio or video stream (in the case of VoD “Video on Demand” or digital television on the Internet) whilst it is transmitted. It is different, therefore, from transmission by downloading which requires collecting all the data of a video segment or excerpt before the video can be listened to or watched. Thus, audio and/or video data packets are transmitted by a server over the Internet network and received by a device, such as a digital television decoder or any other type of device for the playback of audio-visual data (“media player”) connected to the network (a mobile terminal such as a telephone or a personal assistant, for example).

### TECHNICAL BACKGROUND TO THE INVENTION

A device for the streaming reception of audio and/or video data packets thus collects said data packets which it places in a buffer memory which corresponds to part of a RAM-type memory (“Random Access Memory”) or any type of rapid access memory (hard disk, USB key, for example). Said memory will be denoted hereinafter by the term “network buffer memory”. The presence of a network buffer memory explains the delay which exists between the moment when the user “calls up” (by clicking on a hypertext link for example) the part or the film on the Internet and the start of the playback of the audio-video file. This buffering is necessary for several reasons:

The first phenomenon that necessitates this buffering is jitter, which is a phenomenon of signal fluctuation. This fluctuation may be a phase slip or a temporal dispersion. Thus, as the packets are transported in “best effort” mode, the data may arrive more or less rapidly and said jitter causes output errors when the data is recovered. Thus, in order to be able to maintain playback synchronisation, the device for receiving packets buffers the received data so as to smooth out variations in transmission time and/or transmission rate. It is also noteworthy that the data packets do not always arrive in order and it is thus appropriate to regroup them and arrange them in the correct order in the network buffer memory.

Furthermore, within the context of transmitting audio-video images on the Internet network, where generally the high rate of transmission errors is characterised by packet loss, it is appropriate to protect the data packets by using, amongst others, error correction codes such as forward error correction (FEC) codes. FECs add redundant elements of the digital message to the data before the audio/video signal is transmitted, so that they can be verified at reception and thus reduce the risk of errors associated with the transmission which would interfere with the reception. The “FEC COP#3r2” standard of the “Pro MPEG Forum” describes an'implementation of the FEC function.

More and more operators use FEC coding: typically by overloading the quantity of initial packets by about 20%, the number of missing packets is considerably reduced. The introduction of these correction codes naturally results in additional calculation time during which the data have to be buffered (i.e. stored in the buffer memory).

Moreover, the use of an RTP-type data transmission protocol (“Real-time Transfer Protocol”) for transmission in real time in conjunction with an RTCP-type protocol (“Real-time. Transfer Control Protocol”) for controlling the data stream also requires the use of a network buffer memory. The device receives packets via the RTP protocol; when it detects a missing packet it transmits on a return channel a request according to the RTCP protocol to request the missing packet. It is thus necessary to store the remainder of the data for the time (typically 300 ms) it takes for the missing packet to come back from the server. The RTP and RTCP protocols comply with the descriptions of the documents RFC 3550, 4588 and 4585.

The absence of a network buffer memory for the data packets would cause degradation of the image (interference on the screen such as intermittent video or a frozen image) and/or of the sound (scrambled or metallic sound, for example).

On the other hand, use of this network buffer memory, in which the packets are temporarily recorded as they are received by the device, means that a good compromise must be found between the buffering time and the desired image and/or sound quality. If very good quality is desired, a lengthy buffering time is required (up to 1 s to 3 s for a digital television decoder) thereby resulting in a significant occupancy of the RAM and an extended connection time for the user. Similarly, for example in the case of a “multicast” television transmission (that is to say a point-to-multipoint transmission which makes it possible to make bandwidth savings by passing only one packet, even when it is intended for a plurality of destinations) the time taken for changing channels (“zapping” or “TV surfing”) is also extended. In the case of VoD, the fast forward and fast rewind operating modes (“trick mode”), the initiation of a video or the initiation of a sequence in a list of files (“playlist”) are also affected. These modes are not actually implemented locally; as they make use of the server, they require a longer buffering time.

One known solution for responding to this need for a compromise consists in adapting the buffering time via exchanges between the server and the receiving device. The receiving device thus has a variable buffering time. The receiving device sends a request to adjust the buffering time and receives signals originating from the source server that controls the adaptation of the storage time.

However, the implementation of such a solution for configuring the buffering time (also sometimes referred to as “bufferisation” hereinafter) poses certain difficulties.

Thus, a first drawback with this solution is the increased traffic caused. This increased traffic causes interference with access to the network and a not inconsiderable increase in cost.

Moreover, such a solution requires the addition of equipment for the network (in particular in terms of equipment for the head end).

### GENERAL DESCRIPTION OF THE INVENTION

In this context, the object of the present invention is to provide a device for the streaming reception of audio and/or video data packets transmitted over a network from a source server, permitting effective adjustment of the buffering time to compensate for inherent interference in the network whilst overcoming the aforementioned problems.

To this end, the invention suggests a device for the streaming reception of audio and/or video data packets transmitted over a network from a source server, the receiving device comprising:
a network buffer memory in which said packets may be stored, the network buffer memory exhibiting a variable buffering time,
means for adapting the buffering time of the packets with a view to improved playback performance,
   the device being characterised in that it comprises means for locally determining the value of at least one quality of service indicator, the means for adapting the buffering time adapting the buffering time as a function of the value of the QoS indicator.

As a result of the invention, the buffering time is determined locally by determining at least one QoS indicator without a control signal from the server: this local processing of the receiving device results in the following advantages:
it is not the network that adapts the duration of buffering time (thus no network overload),
there is no outlay on the part of the operator to carry out the adaptation since everything is carried out locally,
the invention may be applied to “multicast” and “unicast” transmissions,
the user does not have to operate the device via configuration menus which may be perceived as complex.

It is the device according to the invention that is in charge of determining the best possible compromise between the buffering time, the desired image and/or sound quality, and the connection and navigation time in VoD. Thus, a very short bufferisation time leads to:
average image and sound quality if the line is of mediocre quality,
a nominal connection and navigation time in VoD.

Conversely, a longer bufferisation time leads to:
good image and sound quality even if the line is of mediocre quality,
a very long connection and navigation time in VoD (up to 1 to 2 s more than the nominal case).

Reception problems are often specific to each subscriber, the advantage of the device according to the invention being that the adaptation is made dynamically without the subscriber having to request the operator to configure the device or configure the buffer size himself.

The device according to the invention may also have one or more of the following features, considered individually or according to all the combinations which are technically possible.

Advantageously, the buffering time is less than 3 s (preferably less than 2 s) and greater than 100 ms.

Advantageously, the quality of service indicator is selected from the following indicators:
the number of missing packets,
the latency during a request for a missing packet (for example in the case of a unicast transmission with RTP/RTCP type detection of missing packets),
the audiovisual rendering.

According to one embodiment, the means for adapting the buffering time adapt the bufferisation time according to the ratio between the value of the quality of service indicator and the duration of use of the receiving device.

According to a variant, the means for adapting the buffering time adapt the time when the value of the quality of service indicator exceeds a critical threshold. This adaptation may be made when the value of the quality of service indicator exceeds the critical threshold at least for a specified time.

Advantageously, the means for adapting the buffering time are adapted according to the type of data packets, said means being able to react differently according to whether the data packets are of the video on demand type or television type.

According to a variant, the data packets are packets corresponding to a television signal, the device according to the invention comprising means for detecting a channel most particularly watched by the user, and the means for adapting the buffering time adapting specifically the time for storing packets corresponding to the detected channel.

Advantageously, said means for determining locally the value of at least one quality of service indicator comprise means for the reinitialisation of said value.

Advantageously, said means for adapting the buffering time of packets for the purpose of improved playback performance becomes more accurate over time by training.

The device according to the invention is particularly suitable for the field of television decoders.

### BRIEF DESCRIPTION OF THE FIGURES

Further features and advantages of the invention will emerge clearly from the description provided below, for exemplary purposes and without limitation thereto, with reference to the accompanying

FIG. 1, which is a simplified schematic representation of an architecture using a device according to the invention.

### DESCRIPTION OF PREFERRED EMBODIMENTS OF THE INVENTION

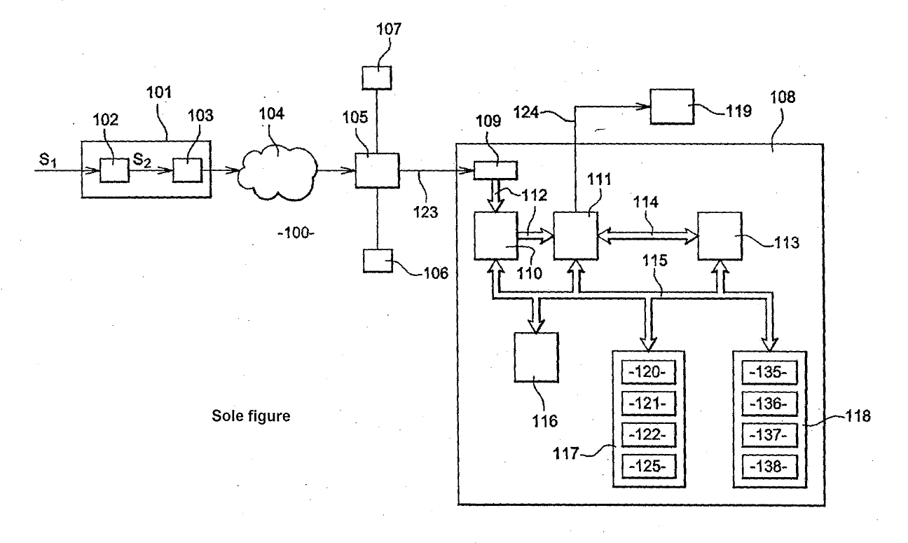

FIG. 1 shows an architecture 100 using a device 108 according to the invention. In the example shown, device 108 is a digital television decoder.

Architecture 100 further comprises:
a television receiver 119, telephone 106 and a microcomputer 107,
a modem 105,
a network 104 of the Internet type,
a remote source 101 of audio video data such as a remote server.

Modem 105 is a “triple play” modem of the ADSL type (“Asymmetric Digital Subscriber Line”) providing the user with access to the three services, television or video on demand VoD via television 119, telephony via telephone 106, and Internet via microcomputer 107.

Server 101 comprises an encoder 102 and an encapsulation device 103.

Whether it is VoD or a television signal, it is based on a native audio video signal S₁ which undergoes MPEG-2 type compression and encoding in encoder 102 to produce an MPEG-2 signal S₂. Although the description is based on the MPEG-2 video coding standard, other similar standards may be used such as MPEG-4 or H263.

The audio video signal S₂ is not transmitted over distribution network 104 in its basic format as it appears after the phase of compression and encoding into MPEG-2. It is split into audio video packets, multiplexed with one another and encapsulated into a specific stream for transport known as MPEG-2 TS (“Transport Stream”). This single stream is split and inserted into the RTP packets (“Real-time Transport Protocol”), possibly with FEC type error correction systems. The packets are then encapsulated into UDP (“User Datagram Protocol”) or TCP (“Transmission Control Protocol”) packets incorporating all the constituent elements necessary for the reconstruction of the program themselves transmitted in IP datagrams. It is noteworthy that the invention applies solely to the case of audio video packets transmitted by “streaming” (thus data which have to be played in real time on television receiver 119).

The data packets are received by modem 105 via a DSLAM multiplexer, (“Digital Subscriber Line Access Multiplexer”), not shown, which transmits these packets to a packet receiving device 109 of decoder 108.

Access to the television channels or VoD requires the use of decoder 108, of which the primary function is to decode the video data stream compressed into the MPEG-2 format. Digital data receiving device 109 and modem 105 are connected by an Ethernet cable 123. It is noteworthy that this connection might also be a WiFi or WiMAX connection.

Decoder 108 comprises:
a network buffer memory 110
a microprocessor 116 controlled by programs located in a program memory 117,
a data memory 118,
buses 112, 114, 115 for data addresses and controls enabling the different elements of decoder 108 to be connected to one another and also enabling microprocessor 116 to communicate with these elements in order to manage them,
an MPEG-2 type data decoder device 111.

Decoder 108 receives via receiver 109 compressed data packets which are transmitted to network buffer memory 110 and then to MPEG-2 decoder 111 to be played back on television receiver 119 via a SCART socket 124. It is noteworthy that MPEG-2 decoder 111 uses an audio-video (AV) buffer memory 113. Thus, in the case of a video sequence at the MPEG-2 standard, said video sequence may be composed of three types of images: I (Intra), P (Predicted) and B (Bidirectional). These images are not all processed and compressed in the same manner. The P images are predicted from the preceding I or P images. The B images are also predicted images but they have the particularity of being able to be interpolated from past and/or future I or P images. A B image may only be decoded if the I or P images which serve as reference (in particular the future images) are available. This explains the presence of AV buffer memory 113, which temporarily stores the I and P images already decoded by MPEG-2 decoder 111, for the time that MPEG-2 decoder 111 decodes the following P and B images. The images are then replaced in their normal order. Here it is seen that AV buffer memory 113 depends on the type of compression algorithm used and that its function is completely different from that of network buffer memory 110.

The data throughput transmitted to decoder 108 may vary typically between 1.5 Mbit/s and 12 Mbit/s. As has been explained above, the packets are temporarily recorded as they are received by network buffer memory 110 to remedy various problems such as:
problems associated with jitter,
the use of an FEC-type error correction code resulting in an additional calculation time,
the use of RTP/RTCP-type protocols which entails additional waiting time for sending the request and receiving missing packets.

It is noteworthy that in multicast or unicast transmission without a return channel, only FEC coding is possible, the use of the RTCP protocol involving the presence of a return channel. In unicast transmission with a return channel, it is possible to have:
an FEC coding
use of the RTP/RTCP protocols
a combination of the FEC coding+the RTP/RTCP protocols (for example to request packets that might not have been corrected by the FEC coding).

It is necessary to find the best possible compromise between the buffering time, the desired image and/or sound quality and the connection and navigation time in VoD. Thus a very short bufferisation time results in:
average image and sound quality if the line is of mediocre quality,
a nominal connection and navigation time in VoD,

Conversely, a longer bufferisation time results in:
good image and sound quality even if the line is of mediocre quality,
a very long connection and navigation time in VoD (up to 1 to 2 s more than the nominal case).

Network buffer memory 110 may form part of a RAM-type memory of which the overall size is, for example, 128 or 256 MB for a digital television decoder, typically with a section in the order of 512 KB to 5 MB dedicated to network buffer memory 110.

In order to implement this compromise, the buffering time is variable: this time might typically vary between 100 ms and 3 s (preferably less than 2 s or even 1 s) for a digital television decoder with a default value in the order of 300 ms. Incidentally, it may be noted that this default value may vary according to the destination of the decoders if the operator knows the country for which the decoders are intended.

Data memory 118 is, in particular, intended to store various information, values or parameters necessary for the operation of the decoder. The data memory thus comprises, in particular, QoS indicators of variable value which may be, for example:
the number of missing packets 135,
the latency during a request for a missing packet 136,
the audiovisual rendering 137 on television receiver 119 via, for example, the indicator of the number of errors corresponding to frozen images.

The number of missing packets corresponds to the number of undelivered data packets, the majority of the time due to network congestion. This number of missing packets is provided by a continuity counter of which the value is coded on 4 bits for the TP packets (“Transport Packet”) defined by the MPEG-2 systems standard ISO/IEC 13818-1. If the RTP protocol (RFC 3550) is used, the “sequence_number” field (coded on 16 bits) of the header may also be used.

The latency during the missing packet request is determined via the RTP/RTCP protocols: when a missing packet request is transmitted according to RTP (RFC 3550) the latency corresponds to the time passed between the transmission of the request and the return of the missing packet via RTCP.

Concerning the audiovisual rendering indicator, as regards the MPEG-2 decoder 111, there are two main cases of errors associated with the filling rate of AV buffer memory 113:
“under-flow” type error: MPEG-2 decoder 111 consumes data more rapidly than the data arrive. If MPEG-2 decoder 111 has no more data, it may no longer decompress the subsequent images and in this case, the last image which has been able to be decompressed remains frozen on television receiver screen 119.
“over-flow” type error: the data arrive more rapidly than MPEG-2 decoder 111 is able to consume them: AV buffer memory 113 overflows and the data are thus lost. The consequence is that the interference is visible on the screen of television receiver 119.

MPEG-2 decoder 111 raises the alarm (interruptions for example) each time it encounters this type of error and it is thus possible to monitor these errors (and thus the audiovisual rendering) via an indicator.

It is noteworthy that these indicators are solely provided by way of example and the invention also relates to other types of indicators. It is also noteworthy that decoder 108 may either use a plurality of indicators or just one.

Data memory 118 also comprises an indicator 138 supplying the duration of use of decoder 108 by the user (that is to say the number of display hours on television receiver 119).

Program memory 117 is, in particular, intended for managing different operations to be executed, to implement different functionalities of decoder 108. It comprises a plurality of software means (applications) of which some are dedicated to implementing the invention. In other exemplary embodiments of decoder 108, these software means might be replaced by specific electronic circuits.

Thus program memory 117 comprises:
means 120 for adapting the buffering time for packets for the purpose of improved playback performance,
means 121 for locally determining the value of at least one of the quality of service indicators 135, 136 and/or 137,
means 122 for calculating the ratio of the average value of the QoS indicator to the duration of display.

Thus, decoder 108 continuously locally memorises monitoring data from at least one QoS indicator 135, 136 and/or 137 via means 121.

After a predetermined period (which may be, for example, one day, one week or one month), decoder 108 calculates the ratio of the average value of one of the QoS indicators (for example the number of missing packets 135) to the duration of use 138. If this ratio exceeds a specific threshold, decoder 108 activates its means 120 in order to increase the storage time of the packets in network buffer memory 110 for the purpose of improved playback performance of the image. Conversely, if this ratio falls below another threshold, decoder 108 may reduce the storage time in network buffer memory 110 in order to improve the “trick mode” time lag in the case of VoD or the connection time (zapping) in the case of a TV stream without a return channel.

Thus, decoder 108 periodically readjusts the bufferisation time. Means 121 for locally determining the value of at least one QoS indicator also comprises means for reinitialisation to zero of the QoS value after each adjustment of the bufferisation time. Each decoder 108 is adapted to the quality of the transmission line according to one or more QoS indicators calculated locally (thus without being controlled by a signal originating from the network); a decoder which has a very good reception quality, (for example because the transmission is made via fibre optics or because the subscriber is located close to the DSLAM) will have a semi-instantaneous “trick mode” in the case of VoD, a semi-instantaneous connection time in the case of a TV stream without a return channel, and a reduced bufferisation time because the QoS indicator will indicate good quality. Conversely, for a subscriber who lives near a lift or tramway, and who has great difficulty with the reception quality (electromagnetic interference, for example), there will be a longer bufferisation time so as to favour the image quality (and thus a longer VoD “trick mode” or TV connection time). Decoder 108 is thus an “intelligent” system with dynamic and local auto-adaptation according to the quality of service, without any modification to the bufferisation time which would be controlled by the network.

It will be noted that the decoder according to the invention is capable of learning. In other words, the adjustment of the bufferisation time will become more accurate as the history of the QoS values held by the decoder increases (that is to say, means 120 for adapting the buffering time of the packets for the purpose of improved playback performance becomes more accurate over time by training).

It is also possible to implement an adaptation of the bufferisation time by type of data packet and thus services provided to the user: thus depending on whether the service is television (denoted by the term “live”) or VoD, the bufferisation time may be adjusted differently by means 120.

An example of training for the decoder according to the invention will be disclosed hereinafter.

On certain TV packages, different types of services coexist with different transmission rates:
channels transmitted in MPEG-2, of which the transmission rates are in the order of 4 Mbit/s: these services will be called the MPEG-2 group hereinafter,
channels transmitted in H264, of which the transmission rates are in the order of 1.7 Mbit/s: these services will be called the H264 group hereinafter.

The impact of poor reception quality on the line will be more significant as the transmission rate increases:
the MPEG-2 group has mediocre quality with an increased number of errors in the QoS indicator,
the H264 group has average quality with a low number of errors in the QoS indicator.

Let us suppose now that the user principally watches the channels of the MPEG-2 group as they constitute the Premium Package. The following cycle is put in place:

### Step 1—D Day:

installation of the device according to the invention by the subscriber,
bufferisation time=default values=500 ms.

### Step 2—D Day+2:

the indicators are as follows:
   MPEG-2 group: very poor QoS indicator and duration of display=5 h.
   H264 group: average QoS indicator and duration of display=20 minutes.
      Step 3—D day+2:
the device increases the bufferisation to a maximum (same bufferisation whatever the services): bufferisation time=2 s.

### Step 4—D Day+2:

the indicators are reinitialised to 0.

### Step 5—D Day+4:

the indicators are as follows:
   MPEG-2 group: excellent QoS indicator and duration of display=5 h
   H264 group: excellent QoS indicator and duration of display=20 minutes.

### Step 6—D Day+4:

the device reduces the bufferisation: bufferisation time=1 s.

### Step 7—D Day+4:

the indicators are reinitialised to 0

### Step 8—D Day+6:

the indicators are as follows:
MPEG-2 group: average QoS indicator and duration of display=5 h.
H264 group: very good QoS indicator and duration of display=20 minutes

### Step 9—D Day+6:

the device slightly increases the bufferisation: bufferisation time=1.2 s.

### Step 10—D Day+6:

the indicators are reinitialised to 0

### Step 11—D Day+8:

the indicators are as follows:
   MPEG-2 group: good QoS indicator and duration of display=5 h
   H264 group: excellent QoS indicator and duration of display=20 minutes

### Step 12—D Day+8:

the device does not modify the parameters as:
   MPEG-2 group has a satisfactory ratio of the QoS indicator to a significant duration of display
   H264: indicator is “too” good (zapping time unnecessarily affected) but with an insignificant duration of display

### Step 13: D Day+20:

the indicators are as follows:
   MPEG-2 group: average/good. QoS indicator and duration of display=30 h.
   H264: excellent QoS indicator and duration of display=2 h (considered to be a significant duration)

### Step 14—D Day+20:

the device implements different processing according to the type of services:
   MPEG-2 group: bufferisation time slightly increased to 1.3 s.
   H264 group: bufferisation time reduced to 0.8 s.

### Step 15—D Day+20:

the indicators are reinitialised to 0

### Step 16—D Day+30:

the indicators are as follows:
   MPEG-2 group: good QoS indicator and duration of display=20 h
   H264 group: good QoS indicator and duration of display=2 h.

### Step 17:

no change carried out by the device.

In this example, it has taken 30 days for the device according to the invention to be adapted in the best manner. However, if the operator changes the transmission parameters (for example because some of the services of the Premium Package change to H264 or because the user uses a WiFi module (which adds interference) between the decoder and the ADSL modem) the parameters will be readjusted again automatically.

Although the determination of the QoS indicators is made in real time, it is noteworthy that the modification of the buffering time will only take effect at the next connection to a stream of decoder 108 (corresponding for example to zapping in the case of a multicast TV stream or a trick mode in the case of VoD). Modification of the bufferisation time in real time would inevitably cause visible interference for the user.

According to a variant of the invention, the buffering time may be adapted every time one of the QoS indicators exceeds a critical threshold; for example if the indicator of the audiovisual rendering indicates a frozen image every 5 s, means 120 will immediately increase the bufferisation time and this new bufferisation time will produce results at the next connection of decoder 108.

It is also possible to combine the two embodiments by carrying out:
one calculation per period (day, week or month) with possible adjustment,
a systematic adjustment (independent of the calculation period) if a critical threshold is exceeded.

An even more accurate adaptation may be made for each television channel, since each channel does not have the same transmission rate and coding level (some channels may use more or fewer Intra images, for example, which affect the risk of interference). The adjustment of the bufferisation time may thus vary from one television channel to another.

A specific adaption of the bufferisation time for a television channel particularly watched by the user may also be implemented. Device 108 thus comprises means 125 for detecting a channel more particularly watched by the user and means 120 for adapting the bufferisation time specifically adapt the time for storing packets corresponding to the channel detected. On the other hand, it is possible to keep a default bufferisation time for the other television channels. The decoder thus prioritises the image quality of the channel watched the most.

Naturally, the invention is not limited to the embodiment that has just been disclosed.

In particular, in the example illustrated, the embodiment refers to a device for the streaming reception of packets which is a digital television decoder. The invention relates equally well to a receiving device incorporated in the ADSL modem, even to, an independent device for the reception of packets which is located between the ADSL modem and the decoder.

Furthermore, the invention relates to other types of terminal for the reception of data packets by streaming such as mobile terminals (telephone or personal assistant).

However, the invention does not relate to receiving devices having bufferisation times of greater than 3 s, such as microcomputers.

Finally, any means may be replaced by an equivalent means.

1. A device for the streaming reception of audio and/or video data packets transmitted over a network from a source server, said receiving device comprising:
a network buffer memory in which said packets may be stored, said network buffer memory exhibiting a variable buffering time,
means for adapting the buffering time of said packets for the purpose of improved playback performance of said packets, and
means for locally determining the value of at least one quality of service indicator, said means for adapting the buffering time adapting said time as a function of said value of the indicator.

2. The receiving device according to claim 1, wherein the buffering time is less than 3 s.

3. The receiving device according to claim 1, wherein the buffering time is greater than 100 ms.

4. The receiving device according to claim 1, wherein said at least one quality of service indicator is selected from the following indicators:
the number of missing packets,
the latency during a request for a missing packet,
the audiovisual rendering.

5. The receiving device according to claim 1, wherein said means for adapting the buffering time adapt said time according to the ratio between said value of at least one quality of service indicator and the duration of use of said receiving device.

6. The receiving device according to claim 1, wherein said means for adapting the buffering time adapt said time when said value of at least one quality of service indicator exceeds a critical threshold.

7. The receiving device according to claim 1, wherein said means for adapting the buffering time are adapted according to the type of data packets.

8. The receiving device according to claim 7, wherein said means for adapting the buffering time react differently according to whether the data packets are of the video on demand type or television type.

9. The receiving device according to claim 7, wherein the data packets are packets corresponding to a television signal, said device comprising means for detecting a channel more particularly watched by the user and said means for adapting the buffering time adapting specifically the time for storing packets corresponding to said detected channel.

10. The receiving device according to claim 1, wherein said means for determining locally the value of at least one quality of service indicator comprise means for the reinitialisation of said value.

11. The receiving device according to claim 1, wherein said means for adapting the buffering time of packets for the purpose of improved playback performance, become more accurate over time by training.

12. The receiving device according to Claim 1, wherein said device is a digital television decoder.

13. A device for the streaming reception of audio and/or video data packets transmitted over a network from a source server, the device comprising:
a network buffer memory in which said packets may be stored, said network buffer memory exhibiting a variable buffering time; and
a program memory encoded with instructions configured to adapt the buffering time of said packets for the purpose of improved playback performance of said packets and to locally determine the value of at least one quality of service indicator, said instructions configured to adapt the buffering time adapting said time as a function of said value of the indicator.

14. The device according to claim 13, wherein the buffering time is less than 3 s.

15. The device according to claim 13, wherein the buffering time is greater than 100 ms.

16. The device according to claim 13, wherein said at least one quality of service indicator is selected from the following indicators:
the number of missing packets,
the latency during a request for a missing packet,
the audiovisual rendering.

17. The device according to claim 13, wherein said instructions configured to adapt the buffering time adapt said time according to the ratio between said value of at least one quality of service indicator and the duration of use of said receiving device.

18. The device according to claim 13, wherein said instructions configured to adapt the buffering time adapt said time when said value of at least one quality of service indicator exceeds a critical threshold.
